(19) United States
(12) Patent Application Publication
(10) Pub. No.: US 2011/0001838 A1
(43) Pub. Date: Jan. 6, 2011

(54) Method and apparatus for operating camera of portable terminal

(75) Inventor: Sung Hwan Lee, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/803,679

(22) Filed: Jul. 2, 2010

(30) Foreign Application Priority Data
Jul. 2, 2009 (KR) 10-2009-0060197

(51) Int. Cl. H04N 5/225

(52) U.S. Cl. 348/220.1; 348/262; 348/333.05; 348/E05.024

(57) ABSTRACT

A camera operation method and apparatus of the portable terminal includes a camera comprised of a plurality of camera modules. The camera modules are set to be enabled according to corresponding input signals for activating particular user functions, respectively. An enabled camera module captures an image that is used to support a particular user function. The camera modules are configured to be exclusively used for particular functions, respectively, thereby enhancing the data processing speed in the portable terminal.

### CROSS-REFERENCE TO RELATED APPLICATION(S) AND CLAIM OF PRIORITY

The present application is related to and claims priority to and the benefit of Korean Patent Application No. 10-2009-0060197 filed in the Korean Intellectual Property Office on Jul. 2, 2009, the entire contents of which are incorporated herein by reference.

### TECHNICAL FIELD OF THE INVENTION

The present application is related to portable terminals, and more particularly, to a camera operation method and apparatus that can relatively rapidly and precisely preview store images in a portable terminal during the process of acquiring and processing the images.

### BACKGROUND OF THE INVENTION

In recent years, portable terminals have been widely used because they can be easily carried.

Portable terminals can provide various user functions using functions modules installed thereto. Examples of the function modules are an MP3 player module for playing back audio files, a camera module for collecting images, and so forth. Most portable terminals have recently been equipped with a camera module.

Conventional portable terminals with a camera module can preview images captured by the camera module on its display unit and can store captured images according to a user's request.

However, conventional portable terminals are forced to process data slowly while using the camera module installed thereto since they also support the other functions, for example, a call function, a file playback function, a data search function, and the like. That is, conventional portable terminals require additional time to capture, store, and preview images, using their camera module, which inconveniences users so that they cannot capture an image at a desired time point.

### SUMMARY OF THE INVENTION

To address the above-discussed deficiencies of the prior art, it is a primary object to provide an apparatus that includes a plurality of camera modules, divides the camera function among the number of the plurality of camera modules, and allows the respective camera modules to only process corresponding jobs, thereby enhancing the data processing speed in the portable terminal.

The present invention further provides a method that divides the camera function among the number of the plurality of camera modules, and allows the respective camera modules to only process corresponding jobs, thereby enhancing the data processing speed in the portable terminal.

In accordance with an exemplary embodiment of the present invention, the present invention provides a camera operation method of a portable terminal, including: receiving an input signal for activating a particular user function of the portable terminal; enabling particular camera modules of a plurality of camera modules, which are set to be enabled and acquire images when the particular user function is enabled; and supporting the user function based on the image acquired by the enabled camera module.

In accordance with another exemplary embodiment of the present invention, the present invention provides a camera operation apparatus of a portable terminal, including: a camera having a plurality of camera modules that capture images of a subject; a controller that individually activates the plurality of camera modules according to the activation of a particular user function; and an input unit that generates input signals to control the camera modules.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal according to an embodiment of the present invention;

FIG. 2 illustrates a first embodiment of the camera according to the present invention;

FIG. 3 illustrates a second embodiment of the camera according to the present invention;

FIG. 4 illustrates a third embodiment of the camera according to the present invention;

FIG. 5 shows screens displaying images on the display unit, according to an embodiment of the present invention; and

FIG. 6 illustrates a process for operating a camera module in a portable terminal, according to an embodiment of the present invention.

### DETAILED DESCRIPTION OF THE INVENTION

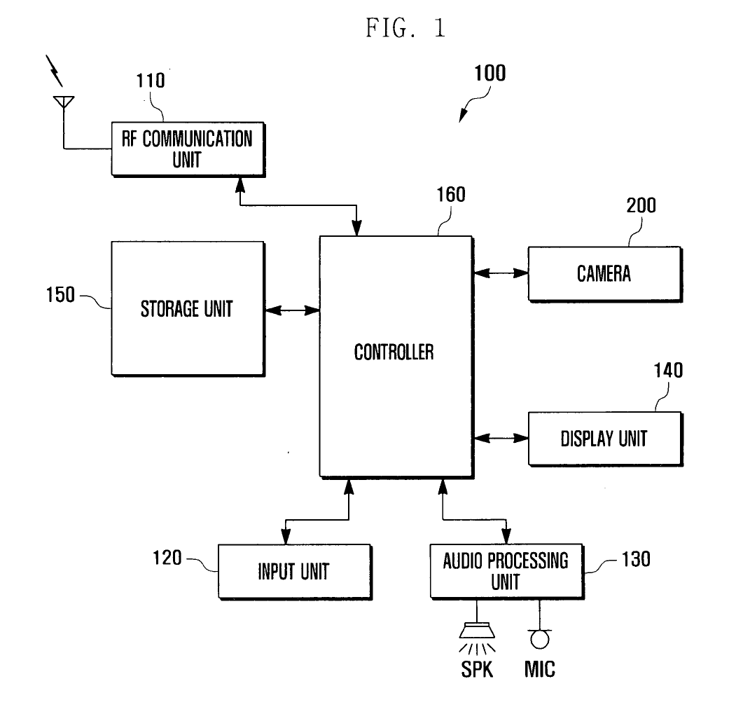

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

Prior to explaining the embodiments of the present invention, terminologies will be defined for the present description below. The terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application.

FIG. 1 illustrates a portable terminal according to an embodiment of the present invention.

Referring to FIG. 1, the portable terminal 100 includes an RF communication unit 110, an input unit 120, an audio processing unit 130, a display unit 140, a storage unit 150, a camera 200, and a controller 160.

The portable terminal 100 is equipped with a plurality of image sensors for acquiring images via the camera 200 and a plurality of image processing modules for processing the acquired images, respectively, thereby rapidly previewing and storing the acquired images. In the following description, each element in the portable terminal 100 is explained in detail.

The RF communication unit 110 establishes a communication channel with a base station and performs data communication and a voice call with the other portable terminals there-through. To this end, the RF communication unit 110 includes an RF transmitter for up-converting the frequency of signals to be transmitted and amplifying the signals and an RF receiver for low-noise amplifying received RF signals and down-converting the frequency of the received RF signals. In an embodiment of the present invention, the RF communication unit 110 can transmit the images acquired by the camera 200 to the other portable terminal under the control of the controller 160.

The input unit 120 includes a plurality of keys and function keys that can input numerical or alphabetical information and set a variety of functions. The function keys include direction keys, side keys, shortcut keys, and so forth, which are set to perform specific functions. The input unit 120 generates key input signals, related to the function control of the portable terminal 100, and outputs them to the controller 160. In an embodiment of the present invention, the input unit 120 can generate input signals for controlling the camera 200 according to a user's input. That is, the input unit 120 can generate an input signal for activating the camera 200, an input signal for setting the environment of the camera 200, an input signal for selectively enabling a plurality of camera modules included in the camera 200, and so forth. Examples of the input signal for setting the environment of the camera 200 are setting the ISO, the shutter speed, the booster, the lamp, and so forth. In addition, when a plurality of camera modules are enabled, the input unit 120 can generate an input signal for activating a function of a portable terminal supported by a corresponding camera module, according to a user's request. Furthermore, the portable terminal 100 can activate a particular user function related to a camera module without an input signal, if the camera module for the particular user function is activated.

The audio processing unit 130 reproduces audio signals, received via the RF communication unit 110, through a speaker SPK under the control of the controller 160, and outputs audio signals from a microphone MIC, such as voice signals, to the RF communication unit 110. The audio processing unit 130 can output the sound effects according to the input for controlling the camera 200, for example, the operation of the shutter button, the storage of the acquired image, and so forth. In an embodiment of the present invention, if a particular camera module is enabled, the audio processing unit 130 can inform the user of a user function supported by the enabled camera module. For example, if a particular camera module is enabled and an image is transferred via the RF communication unit 110, the audio processing unit 130 can output information corresponding to the image transfer function via the speaker SPK.

The display unit 140 displays a variety of menu screens for the portable terminal 100, user's input data, function setting information, information provided to the user, and so forth. The display unit 140 may be implemented with a liquid crystal display (LCD), an organic light emitting diode (OLED), and the like. If the display unit 140 is implemented with a touch screen, it can also serve as an input device. The display unit 140 can display images acquired according to the activation of the camera 200, for example, preview images, stored images, transferred images, and so forth. If at least one of the plurality of camera modules included in the camera 200 is enabled, the display unit 140 displays an image acquired by the enabled camera module. The image can be variously displayed according to the feature of the camera module. For example, if a preview dedicated camera module is enabled, the display unit 140 configures the screen for preview image output. If a storage dedicated camera module is enabled, the display unit 140 may display a still image acquired and stored according to the press of the shutter button or may not display any image. The display unit 140 can display a screen for storing an image, for example, a pop-up screen containing button icons, such as, a storage button, a cancel button, or the like. The display unit 140 does not display a pop-up screen. In that case, if the user inputs a signal corresponding to a shutter key for storing an image, the portable terminal 100 can store the acquired image in the storage unit 150. As described above, if a particular function dedicated camera module is enabled, the display unit 140 can display a screen for supporting the particular function together with an acquired image. Meanwhile, the display unit 140 can display an alarm image if image storage or image transfer has been completed according to an input signal of the input unit 120. If the camera 200 is being operated according to a particular function, for example, multi-shot capturing or moving image capturing, the display unit 140 can also display an image or text showing the function guide message.

The storage unit 150 stores programs required to operate the portable terminal 100, user data, and so forth. It may be configured to include a program storage area and a data storage area.

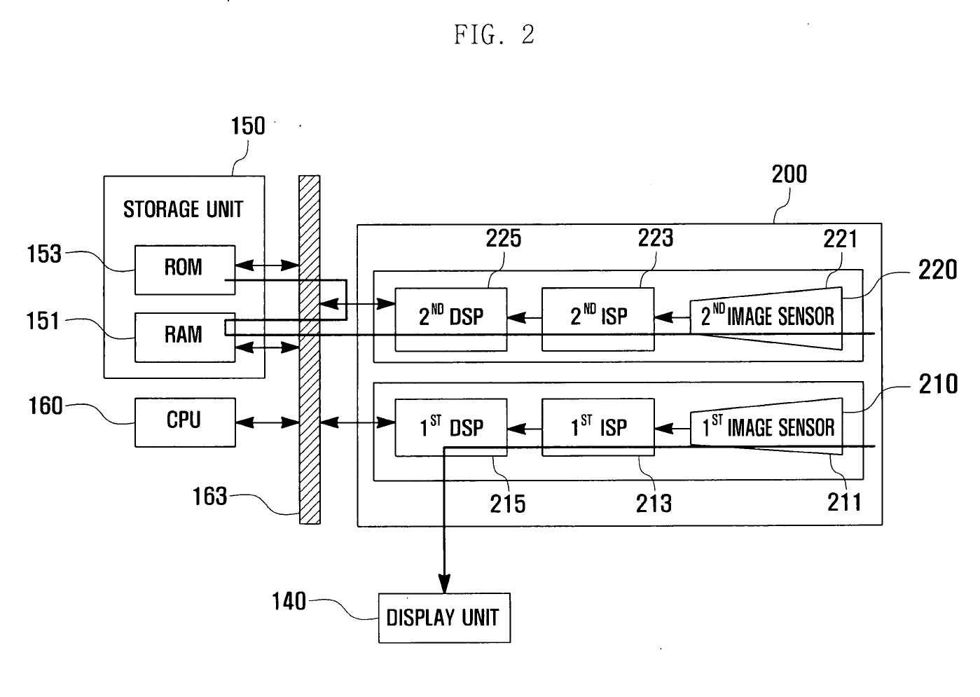

The program storage area stores an operating system (OS) for controlling the entire operation of the portable terminal 100, an application program required to play back multimedia contents, and the like. In an embodiment of the present invention, the program storage area stores a function dedicated program for controlling the camera 200. In order to enable a plurality of camera modules included in the camera 200 according to input signals, the function dedicated program contains a routine for enabling a corresponding camera module and a routine for setting functions exclusively supported by the corresponding camera module. The operation of the plurality of camera modules will be explained in detail with reference to FIG. 2. The routine for setting functions may contain commands for controlling enabling the plurality of camera modules together when a particular input signal is input.

The data storage area refers to an area in which data generated as the portable terminal 100 is used is stored. Examples of the data are a phone book, audio data, contents, information corresponding to user data, and the like. In an embodiment of the present invention, the data storage area can store images acquired according to the activation of the camera 200.

The camera 200 includes a plurality of camera modules. The camera 200 can enable at least one of the plurality of camera modules according to the control of the controller 160 and can support a particular user function set in a corresponding camera module. Each camera module includes a camera sensor for converting an optical signal into an electrical signal, an image signal processor (ISP) for converting an analog video signal into a digital video signal, and a digital signal processor (DSP) for processing the video image, such as scaling, noise removing, RGB signal converting, and so forth, in order to display the video signal, output from the ISP, on the display unit 140. The camera sensor is implemented with a CCD sensor, a CMOS sensor, or the like. The camera module can be implemented without the ISP. In that case, the DSP replaces the function of the ISP. The camera module for supporting a particular user function can be implemented with only the ISP, without the DSP. The configuration of the camera 200 will be explained in detail with reference to FIG. 2.

The controller 160 controls the entire operation of the portable terminal 100 and signal flows among the elements therein. The controller 160 can also control the data processing operation. In an embodiment of the present invention, the controller 160 controls the camera 200 according to the input signals of the input unit 120. That is, the controller 160 can control individually or integrally a plurality of camera modules according to the input signals. The operation of the controller 160 will be described in detail with reference to FIG. 2.

FIG. 2 illustrates a first embodiment of the camera configuration according to the present invention.

In the following description, an embodiment of the present invention explains the configurations of the controller 160, serving as a central processing unit (CPU) for distributing signals to operate the camera 200, and the camera 200 comprised of two camera modules.

Referring to FIG. 2, the camera 200 includes a first camera module 210 and a second camera module 220, and the storage unit 150 includes read only memory (ROM) 153 and random access memory (RAM) 151. The ROM 153 can allow for the reading function and writing function.

When the input unit 120 generates an input signal for activating the camera function, for example, according to a user's request, the controller 160 receives the input signal and enables the first camera module 210. It is assumed that the first camera module 210 is configured to perform a preview dedicated function. When the first camera module 210 is enabled according to the control of the controller 160, it allows the first ISP 213 to convert an image acquired by the first image sensor 211 into a digital signal and allows the first DSP 215 to process the digital signal and to output it to the display unit 140. The display unit 140 receives the signal processed by the first camera module 210 and displays it as a preview image. During this process, the first camera module 210 may directly transfer the signal to the display unit 140 without passing through the control bus 163.

Alternatively, if the portable terminal user inputs a signal for storing an acquired image, the input signal is transferred to the controller 160 via the control bus 163. The controller 160 receives and identifies the input signal and enables a camera module configured to perform a storing operation, that is, the second camera module 220. The controller 160 can enable both the first and second camera modules 210 and 220 at the time that the controller 160 receives the input signal for activating the first camera module 210. Alternatively, the controller 160 can also enable the second camera module 220 when an input signal for storing an image, that is, an input signal for activating the second camera module 220, is generated.

Meanwhile, when the second camera module 220 is enabled according to the control of the controller 160, it allows the second ISP 223 to covert an image acquired by the second image sensor 221 into a digital signal and allows the second DSP 225 to process the digital signal and to output it to the control bus 163. The controller 160 loads the signal from the control bus 163 in the RAM 151 of the storage unit 150. When the portable terminal user presses a key corresponding to the shutter button to capture a subject, the controller 160 temporarily stores the captured image in the RAM 151. After that, the controller 160 may control the display unit 140 to display a pop-up message asking whether the captured image is stored. The input unit 120 generates an input signal according to a user's request and outputs it to the controller 160. If the controller 160 receives an input signal for storing the captured image from the input unit 120, it stores the captured image, stored in the RAM 151, in the ROM 153 via the control bus 163. Alternatively, the controller 160 may delete the captured image from the RAM 151 or overwrite it with a newly input image transferred from the second camera module 220. On the contrary, if the controller 160 receives an input signal corresponding to a cancel command, it may delete the captured image from the RAM 151 or perform a waiting operation by not moving it to the ROM 153.

As described above, when the portable terminal user inputs signals for storing a particular image using the camera 200, the portable terminal 100 stores the particular image via the signal path: the second camera module 220, the control bus 163, the RAM 151, an operation of receiving an input signal for storage, the control bus 163, and the ROM 153, where the second camera module 220 includes the second image sensor 221, the second ISP 223, and the second DSP 225. In addition, the portable terminal 100 displays a preview image via the signal path: the first camera module 210 and the display unit 140, where the first camera module 210 includes the first image sensor 211, the first ISP 213, and the first DSP 215.

As described above, the embodiment of the present invention is implemented in such a way that, when the camera function is activated, the first camera module 210 is enabled in a default mode and then a preview image regarding a subject is acquired and displayed on the display unit 140, it should be understood that the present invention is not limited to the embodiment. For example, if the portable terminal 100 is provided with an input key or a menu for individually selecting the first camera module 210 and second camera module 220 and allows the user to store an image using only the second camera module 220, the first camera module 210 can be retained in a disabled state. That is, the portable terminal 100 can be implemented in such a way that it can enable only the second camera module 220 according to an input signal, and capture and store an image of a subject according to a user's input signal for capturing and storing an image. In that case, when a pop-up message for storing the captured image is displayed, the second camera module 220 may transfer a preview image for the captured image to be stored to the display unit 140. That is, when only the second camera module 220 has been enabled, the controller 160 temporarily stores signals corresponding to the image transferred from the second camera module 220 in the RAM 151 and also transfers them to the display unit 140 via the control bus 163. The display unit 140 displays the image to be stored.

The portable terminal 100 according to the present invention can also process data at a high speed during the process of capturing a multi-shot or a moving image, by individually specializing and controlling the functions of camera modules. The controller 160 can perform an operation for capturing a multi-shot or a moving image, using the second camera module 220, according to a user's request. The image captured by the second camera module 220 can be temporarily stored in the RAM 151 of the storage unit 150 or directly stored in the ROM 153 according to a user's settings. The controller 160 can enable the first camera module 210 according to a user's request and display a preview image of the captured image on the display unit 140. In an embodiment of the present invention, the portable terminal can independently operate the first camera module 210 for displaying a preview image and the second camera module 220 for storing a multi-shot or a moving image, thereby not generating duplicated data and thus performing data processing without affecting the speed of storing the captured image and the speed of displaying the preview image. In particular, since the controller 160 directly displays the preview image on the display unit 140 without controlling the control bus, the data transfer path can be simplified, which reduces the number of commands for processing data and the transferring number of commands, thereby enhancing the data processing speed.

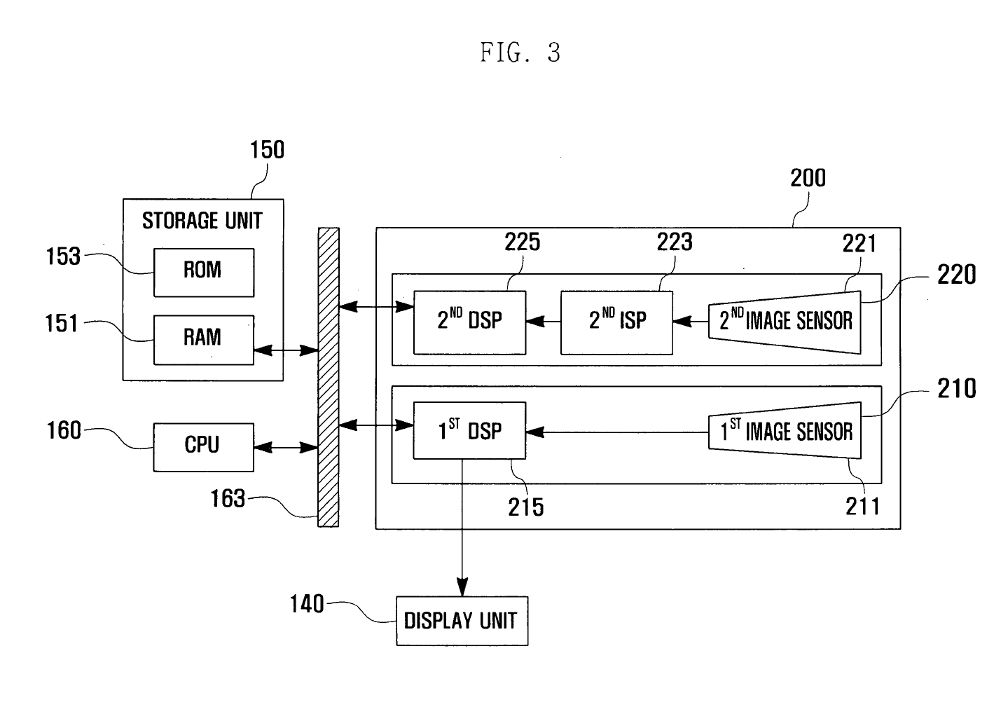

As described above, although the embodiment is implemented in such a way that the first camera module 210 for supporting an image preview function includes the first ISP 213 and the first DSP 215, it may be modified so that it is configured without the first ISP 213 as shown in FIG. 3. Alternatively, the first camera module 210 can also be configured without the first DSP 215. If the first camera module 210 is implemented without the first ISP 213 as shown in FIG. 3, it can allow the first DSP 215 to process the signals acquired by the first image sensor 211. To this end, the first DSP 215 converts the analog signals acquired by the first image sensor 211 into digital signals. Likewise, if the first camera module 210 is implemented with the first ISP 213 and the first image sensor 211, without the first DSP 215, it allows the first ISP 213 to directly convert the images acquired by the first image sensor 211 into digital signals and to output them to the display unit 140. The first camera module 210, without the first DSP 215, cannot perform a digital signal processing regarding the images acquired by the first image sensor 211, for example, scaling, noise removal, RGB signal conversion, and the like; however, it can display a preview image based on the first ISP 213.

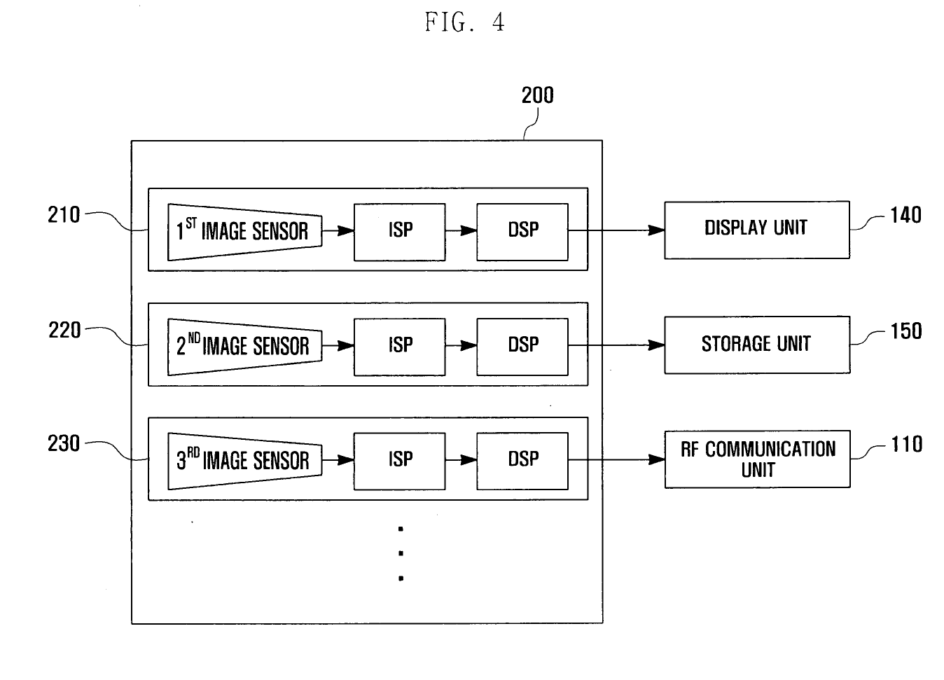

As described above, although the embodiment of the portable terminal is implemented in such a way that its camera includes two camera modules, it should be understood that the present invention is not limited to the embodiment. For example, as shown in FIG. 4, the embodiment can be modified in such a way that it includes a plurality of image sensors and a plurality of image processing modules for processing images acquired by the plurality of image sensors, respectively. The modification of the present invention is explained in detail with reference to FIG. 4.

Referring to FIG. 4, the camera 200 includes a first camera module 210, a second camera module 220, a third camera module 230, and so forth. The first camera module 210 may serve to perform an image preview function only. To this end, the first camera module 210 is comprised of a first image sensor, an ISP, and a DSP. The portable terminal can establish a signal path with the first camera module 210 and the display unit 140 in order to support the image preview function only. The second camera module 220 may serve to perform an image storage function only. To this end, the second camera module 220 is comprised of a second image sensor, an ISP, and a DSP. The portable terminal can establish a signal path with the second camera module 220 and the storage unit 150 in order to support the image storage function only. The third camera module 230 may serve to perform an image transfer function only. To this end, the third camera module 230 is comprised of a third image sensor, an ISP, and a DSP. The portable terminal can establish a signal path with the third camera module 230 and the RF communication unit 110 in order to support the image transfer function only. In order to transfer the image acquired by the third camera module 230 to the RF communication unit 110, the portable terminal loads a signal on the control bus 163 and performs a reading process. That is, the portable terminal can establish a signal path with the third camera module 230, the control bus 163, and the RF communication unit 110 in order to support an image transfer function only.

As described above, since the portable terminal according to the present invention allows a plurality of camera modules included therein to process user functions related to the image process, respectively, it does not duplicate data processing, thereby enhancing the data processing speed and also reducing the data processing load of the controller.

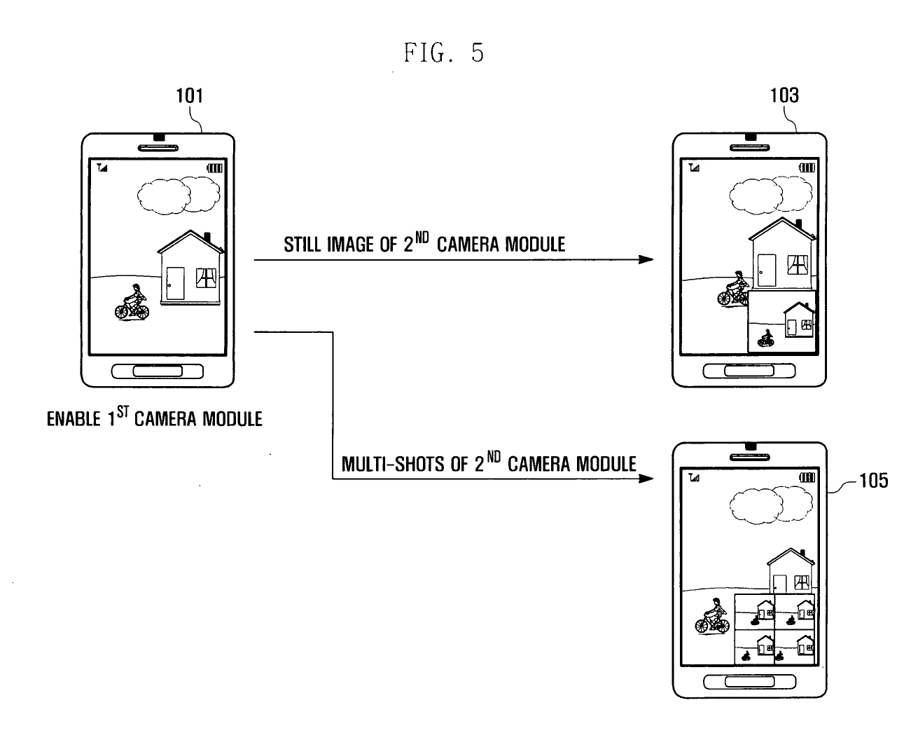

Meanwhile, the display unit 140 can differentiate and display the images acquired by the plurality of camera modules. As shown in screen 101 of FIG. 5, the display unit 140 displays a preview image acquired by the first camera module 210. If the second camera module 220 is enabled and captures a still image of a subject while the preview image is being displayed, the display unit 140 overlays and displays one of a captured still image, a moving image, and a multi-shot image on one side of the screen showing the preview image, as shown in screen 103 of FIG. 5. That is, the display unit 140 can display one of a captured still image, a moving image, and a multi-shot image on an area of the screen, differentiating the preview image. The display unit 140 overlays and displays a pop-up message for storing an image, captured by the second camera module 220, on one side of the screen or on an area of the screen on which the image captured by the second camera module 220 is displayed. The area of the screen, on which the image captured by the second camera module 220 is displayed, may be a certain area on the screen. The certain area can be set via a menu option provided to the portable terminal. That is, the portable terminal user can determine an area on which the image captured by the second camera module 220 will be displayed, using the menu option, before storing the captured image. If the portable terminal user sets the menu option so that the image captured by the second camera module 220 cannot be displayed on the display unit before it is stored in the storage unit, the portable terminal can immediately store it in the storage unit without performing a display process for storage. On the other hand, if the second camera module 220 performs a multi-shot capturing operation of a subject, the display unit 140 can display a plurality of multi-shot images on one side of the screen as shown in screen 105 of FIG. 5. If the third camera module 230 is enabled, the display unit 140 can independently display the image captured by the third camera module 230 on a certain area of the screen. When the first, second and third camera modules 210, 220 and 230 are enabled and capture images, respectively, the portable terminal divides the screen of the display unit 140 into areas corresponding to the number of the camera modules and displays the images captured thereby on the separated areas, respectively.

While a preview image is being displayed, the portable terminal can divide a certain area of the screen of the display unit 140 into sub-areas corresponding to the number of camera modules using a particular key or a button (not shown) provided to the portable terminal, and can then display the images, captured by the camera modules, on the separated areas, respectively. Alternatively, while a preview image is being displayed, the portable terminal can divide a certain area of the screen of the display unit 140 into sub-areas corresponding to the number of camera modules using a particular key or a button (not shown) provided to the portable terminal, and can selectively remove corresponding images displayed on the separated areas or all the separated areas to display only the preview image.

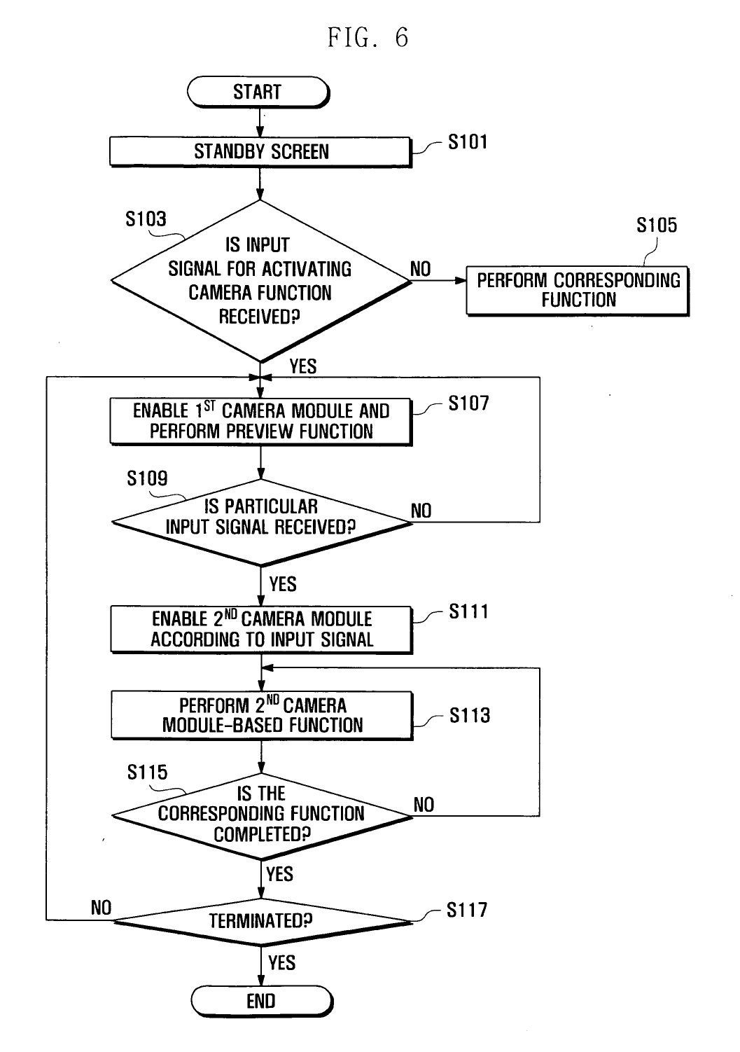

The following description explains a method for operating a camera to efficiently process data in a portable terminal with reference to FIG. 6.

FIG. 6 illustrates a process for operating a camera module in a portable terminal, according to an embodiment of the present invention.

It is assumed that the camera includes two camera modules and has an image preview function. It is also assumed that the portable terminal selectively enables or disables the image preview function according to a user's settings.

Referring to FIG. 6, when the portable terminal is turned on, it initializes its elements and operates in a standby state, displaying a standby screen on the display unit (S101).

The portable terminal determines whether an input signal for activating the camera function is received (S103). If the portable terminal ascertains that a signal for another function, such as a file playback, a file search, a call connection, or an incoming call connection, has been received at S103, it performs a function corresponding to the input signal (S105).

In contrast, if the portable terminal ascertains that an input signal for activating the camera function is received at S103, it enables a first camera module of the plurality of camera modules included in the camera and performs a preview function (S107), where the first camera module is set to operate in a default mode and the preview function is set to be performed in a default mode. Alternatively, step S107 may be implemented in such a way a function set according to a user's selection can be performed, instead of performing the function set with the default camera module. In that case, if the preview function is not set with a default function, step S107 may be omitted.

After that, the portable terminal determines whether an input signal for activating a user function, operated by a particular camera module, is received (S109). If the portable terminal ascertains that an input signal for activating a user function is not received at S109, it returns to and proceeds with step S107. Alternatively, if the portable terminal ascertains that an input signal for activating a user function is received at S109, it enables the second camera module (S111). To this end, the portable terminal can be set to be activated when the second camera module receives the input signal. That is, the second camera module may be previously set to support a particular user function according to the particular input signal. Therefore, when the particular input signal is received, the second camera module can be enabled and perform the particular user function.

Next, the portable terminal performs a corresponding function based on the second camera module (S113). For example, if the second camera module is configured to perform an image storage function only, the portable terminal acquires an image using the second camera module when a signal corresponding to a shutter key is input from the input unit, and stores the acquired image in the storage unit according to a user's request. If the second camera module is configured to perform an image transfer function only, the portable terminal acquires an image using the second camera module when a signal for transferring an image is input from the input unit, and transfers the acquired image to the other external system, via the RF communication unit, according to a user's request. In addition, the camera module may be set to perform other portable terminal user functions, that is, an image search function only for comparing a currently acquired image with an image stored in the storage unit and detecting an image similar to the current acquired image from the storage unit. To this end, the portable terminal can establish a signal path: the camera module, and the control bus, the storage unit, in order to support an image search function.

After that, the portable terminal determines whether the particular function based on the second camera module is completed (S115). If the portable terminal ascertains that the particular function based on the second camera module has not been completed at S115, it returns to and proceeds with block S113. Alternatively, if the portable terminal ascertains that the particular function based on the second camera module has been completed at S115, for example, a key input signal for completing a function has been generated, it determines whether a key signal for terminating the camera function is input (S117). If the portable terminal ascertains that a key signal for terminating the camera function is input at S117, it terminates the camera function. On the contrary, if the portable terminal ascertains that a key signal for terminating the camera function is not input at S117, it returns to and proceeds with step S107.

Meanwhile, at step S107, the portable terminal performs a restricted preview function according to the configuration of the first camera module. That is, if the first camera module is configured without the DSP, the portable terminal cannot perform a digital zoom function. Alternatively, if the first camera module is configured to include the DSP, the portable terminal can perform a digital zoom function, a captured image setting function while performing the previewing function, and so forth.

The portable terminal can selectively control the turn-on time of the first and second camera modules. That is, if the first camera module supports a preview function as a default mode, the portable terminal can enable the first camera module when it receives an input signal for activating the camera function. During this process, the portable terminal can enable only the first camera module, by turning-off the second camera module, and can then enable the second camera module at the time point when an input signal corresponding to a user function for supporting the second camera module is generated. Alternatively, the controller can enable the second camera module simultaneously when the first camera module is enabled.

The portable terminal can display at least one of the images acquired by the plurality of camera modules. The portable terminal can divide the screen of the display unit into a certain number of areas and display the images acquired by a plurality of camera modules on the divided areas, respectively. In the process of displaying at least one of the images captured by the plurality of camera modules, the display unit displays a preview image, captured by a particular camera module, on an area of the screen and at least one of the still image, the moving image, and the multi-shot images, acquired by other camera module, on an area of the screen. The portable terminal can overlay and display at least one of the still image, the moving image, and the multi-shot images, on the area of the screen on which the preview image is being displayed.

In addition, the portable terminal can selectively display the images captured by the plurality of camera modules using a particular key or button. For example, when an image is captured by the second camera module and the captured still image is reviewed, the user divides the area of the screen on which the still image is being displayed into sub-areas, by pressing the particular key or button, and displays at least one of the preview image, the moving image, and the multi-shot images, captured by the other camera module, on the separated area. Alternatively, at least one of the preview image, the moving image, and the multi-shot images, captured by the other camera module, can be overlaid and displayed on the area of the screen on which the still image is being displayed. If the particular key or button is pressed once more, the image captured by the other camera module can be removed from the display unit. If two or more images are displayed on the display unit with the still image, they can be removed once or selectively by using the particular key or button.

As described above, the apparatus and method for operating camera modules of the portable terminal, according to the present invention, divides the camera function among the number of the plurality of camera modules, and allows the respective camera modules to only process corresponding jobs, thereby rapidly storing and outputting data and thus more precisely collecting images that the users requested.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A camera operation apparatus of a portable terminal, comprising:
a camera having a plurality of camera modules configured to capture images of a subject;
a controller configured to individually activate the plurality of camera modules according to the activation of a particular user function; and
an input unit configured to generate input signals to control the camera modules.

2. The apparatus of claim 1, wherein the camera comprises at least two of the following camera modules:
a first camera module configured to acquire a preview image and displaying it on a display unit, according to an input signal of the input unit;
a second camera module configured to acquire at least one of the still image and the moving image of the subject and storing it in a storage unit, according to an input signal of the input unit;
a third camera module configured to transfer an acquired image to an external system via an RF communication unit, according to an input signal of the input unit; and
a fourth camera module configured to compare an acquired image with an image stored in the storage unit, according to an input signal of the input unit.

3. The apparatus of claim 2, wherein the controller establishes at least one of the following paths:
a signal path for directly transferring the image, acquired by the first camera module, to the display unit;
a signal path for transferring the image, acquired by the second camera module, to the storage unit via a control bus;
a signal path for transferring the image, acquired by the third camera module, to the RF communication unit via a control bus; and
a signal path for comparing the image, acquired by the fourth camera module, with another image stored in the storage unit via a control bus.

4. The apparatus of claim 2, wherein the first camera module comprises:
an image sensor configured to acquire an analog signal of an image of the subject; and
an image signal processor configured to convert the analog signal into a digital signal and transferring it to the display unit.

5. The apparatus of claim 2, wherein the first camera module comprises:
an image sensor configured to acquire an analog signal of an image of the subject; and
a digital signal processor configured to convert the analog signal into a digital signal and perform a zoom function and an image transformation.

6. The apparatus of claim 1, wherein the camera module comprises:
an image sensor configured to acquire an analog signal of an image of the subject;
an image signal processor configured to convert the analog signal into a digital signal and transfer it to the display unit; and
a digital signal processor configured to perform at least one of: signal processing, scaling, noise removing, and RGB signal processing regarding the image acquired by the image sensor.

7. The apparatus of claim 1, further comprising:
a display unit configured to display at least one of the images acquired by the plurality of camera modules,
wherein the display unit divides its screen into a certain number of areas and displays the images acquired by the plurality of camera modules on the divided areas, respectively.

8. The apparatus of claim 1, further comprising:
a display unit configured to display at least one of the images acquired by the plurality of camera modules; and
at least one of: key and a button, the at least one of the key and the button configured to divide the screen of the display unit on which the image acquired by a particular camera module is being displayed into a certain number of areas, displaying the image acquired by the particular camera module and an image acquired by at least one of the plurality of camera modules other than the particular camera module on the divided areas, respectively, and remove the image acquired by at least one of the plurality of camera modules other than the particular camera module or both the image acquired by the particular camera module and an image acquired by at least one of the plurality of camera modules other than the particular camera module from the divided areas.

9. The apparatus of claim 1, further comprising:
a display unit configured to display at least one of the images acquired by the plurality of camera modules,
wherein the display unit comprises:
an area on which a preview image acquired by a particular camera module is displayed; and
an area on which at least one of a still image, a moving image, and multi-shot images, acquired by the other camera module, is displayed.

10. The apparatus of claim 9, wherein the display unit overlays and displays at least one of the still image, the moving image, and the multi-shot images on the area on which the preview image is being displayed.

11. A camera operation method of a portable terminal comprising:
receiving an input signal for activating a particular user function of the portable terminal;
enabling particular camera modules of a plurality of camera modules, which are set to be enabled and acquire images when the particular user function is enabled; and
supporting the user function based on the image acquired by the enabled camera module.

12. The method of claim 11, wherein receiving an input signal comprises at least one of the following steps:
receiving an input signal for displaying a preview image;
receiving an input signal for storing an image of a subject;
receiving an input signal for transferring an image of a subject to an external system; and
receiving an input signal for comparing an image of a subject with a stored image.

13. The method of claim 12, wherein receiving an input signal for displaying a preview image comprises:
enabling one of the plurality of camera modules to acquire a preview image; and
directly outputting the image acquired by the enabled camera module to a display unit.

14. The method of claim 12, wherein receiving an input signal for storing an image of a subject comprises:
enabling one of the plurality of camera modules to store an image; and
storing the image acquired by the enabled camera module in a storage unit via a control bus.

15. The method of claim 12, further comprising one of:
enabling, when the input signal for transferring an image of the subject is received, one of the plurality of camera modules to transfer an image, and transferring the image acquired by the enabled camera module to an RF communication unit via a control bus; and
enabling, if the input signals are received, camera modules corresponding to the respective input signals and independently processing the images acquired by the enabled camera modules.

16. The method of claim 11, wherein, if the particular user function is to display a preview image, enabling particular camera modules is enabling a camera module for acquiring a preview image and a camera module for storing the acquired image.

17. The method of claim 11, further comprising:
displaying at least one of the images acquired by the plurality of camera modules,
wherein displaying at least one of the images comprises:
dividing the screen of a display unit into a certain number of areas; and
displaying the images acquired by the plurality of camera modules on the divided areas, respectively.

18. The method of claim 11, further comprising:
displaying at least one of the images acquired by the plurality of camera modules,
wherein displaying at least one of the images comprises:
operating a key or button of the portable terminal while an image acquired by a particular camera module is being displayed on a display unit;
dividing the screen of the display unit into a certain number of areas;
displaying the image acquired by the particular camera module and an image acquired by at least one of the plurality of camera modules other than the particular camera module on the divided areas, respectively; and
removing the image acquired by at least one of the plurality of camera modules or both the image acquired by the particular camera module and an image acquired by at least one of the plurality of camera modules from the divided areas.

19. The method of claim 11, further comprising:
displaying at least one of the images acquired by the plurality of camera modules,
wherein displaying at least one of the images comprises:
displaying a preview image acquired by a particular camera module; and
displaying at least one of a still image, a moving image, and multi-shot images, acquired by the other camera module.

20. The method of claim 19, wherein displaying at least one of the images is overlaying and displaying at least one of the still image, the moving image, and the multi-shot images on the area on which the preview image is being displayed.
